(19) United States
(12) Patent Application Publication
(10) Pub. No.: US 2007/0092801 A1
(43) Pub. Date: Apr. 26, 2007

(54) Molten Salt Electrolyte for a Battery and Electrochemical Capacitor

(76) Inventor: Andrew Tipton, Des Moines, IA (US)

Correspondence Address: ANDREW TIPTON, 320 NW UPTOWN TERRACE, UNIT 1A, PORTLAND, OR, 97210, US

(21) Appl. No.: 11/163,627

(22) Filed: Oct. 25, 2005

(51) Int. Cl. H01M 10/40

(52) U.S. Cl. 429/324; 429/340

(57) ABSTRACT

A molten salt electrolyte is disclosed having a high ionic conductivity and a high decomposition voltage for use in electrochemical devices such as batteries, capacitors and electrochromic windows. An electrochemical cell including first and second electrodes and a molten salt electrolyte is disclosed. The electrodes and separator, if there is one, of the electrochemical device are wetted with non-ionic precursors to the molten salt electrolyte. The molten salt electrolyte is formed inside the electrochemical device by the addition of a non-metal oxide such as carbon dioxide or sulfur dioxide.

### FIELD OF THE INVENTION

This invention relates in general to the field of electrolytes for electrochemical devices, and more particularly to electrolytes for lithium and lithium-ion rechargeable batteries and electrochemical capacitors.

### BACKGROUND OF THE INVENTION

Electrochemical devices include cells, batteries, capacitors, timers, coulometers and electrochromic windows. Batteries and capacitors store energy and find use in electric and hybrid vehicles, satellites and portable electronics such as cell phones, computers and music players, to name but a few applications. An ongoing challenge is to develop high gravimetric and volumetric energy density batteries and capacitors capable of delivering high power that are cost effective, rechargeable and safe.

Liquid electrolytes are found in many electrochemical devices including batteries, such as lithium-ion batteries, and electrochemical capacitors. Improvement in ionic conductivity and the cation transport number is desirable. High ionic conductivity is necessary for high-power applications. Liquid electrolytes consist of salt dissolved in one or more solvents. Often the solvents utilized are volatile and flammable. If a battery or electrochemical capacitor is subject to abuse such as heating, crushing, dropping, short-circuiting, puncturing, overcharging and/or overdischarging, the electrolyte can vent from the cell and occasionally ignite, resulting in fire and/or explosion. There exists a need for non-volatile liquid electrolytes with high conductivity and electrochemical devices containing said electrolyte. The electrolytes should perform over a wide temperature range and be cost effective.

Solid electrolytes are non-volatile, but the ionic conductivities are usually several orders of magnitude less than for liquid electrolytes. In addition, solid electrolytes often do not wet electrodes thoroughly. If an electrode changes volume during charge or discharge, contact between a solid electrolyte and electrode may be lost resulting in high cell impedance.

Molten salts, also known as ionic liquids, are non-volatile and operate in a large electrochemical window, yet often have the disadvantage of having high melting points that necessitate high operating temperatures.

A reversible solvent in which a non-ionic liquid (an alcohol and amine base) converts to a molten salt at room temperature upon exposure to carbon dioxide is reported in Nature 436, 11 02 (25 Aug. 2005). The molten salt converts back to the non-ionic liquid when exposed to nitrogen or argon. This reversible solvent is intended for use in organic synthesis and separation where the need to remove and replace solvents between reaction steps is eliminated. The non-ionic liquid is a mixture of 1-hexanol and 1,8-diaza-bicyclo-[5,4,0]-undec-7-ene (DBU). The reaction scheme is as follows.

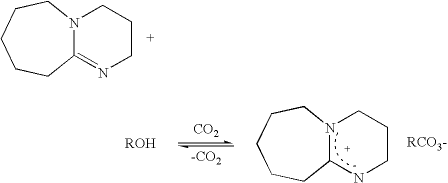

### SUMMARY OF THE INVENTION

An object of the present invention is to provide a non-volatile molten salt electrolyte that avoids the above-mentioned problems. A further object of the present invention is to provide electrochemical devices containing such an electrolyte. A further object of the present invention is to provide a method of wetting electrodes and separator with a molten salt electrolyte.

In the present invention, a conductive molten salt electrolyte is obtained by making an organic molten salt and adding additional salt. The additional salt is often necessary because the ions that make-up the molten salt may not be the ions needed for operation of an electrochemical device. For example, lithium and lithium-ion batteries require mobile Li+ in the electrolyte.

The molten salt is made by combining an amine base and an alcohol which convert to a molten salt when exposed to a non-metal oxide. A particularly preferred amine base is 1,8-diaza-bicyclo-[5,4,0]-undec-7-ene (DBU). A particularly preferred alcohol is 1-hexanol. A particularly preferred non-metal oxide is carbon dioxide. When carbon dioxide is bubbled through non-ionic DBU and 1-hexanol, a molten salt, the DBU salt of 1-hexylcarbonate is formed. The molten salt reverts back to the amine base and alcohol when exposed to nitrogen or argon. Dihydric alcohols (diols), trihydric alcohols (triols) such as glycerol and polyols are also suitable.

The cation of the molten salt is a cyclic organic cation selected from the group consisting of the structures below and combinations thereof.

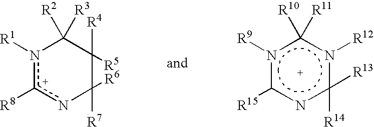

The substituents, R¹ to R¹⁵, are the same or different and are selected from the group consisting of H, halogens, C₁-C₁₅ alkyl and C₁-C₁₅ haloalkyl and combinations thereof. R¹ to R¹⁵ may connect with one another to form bicyclic, tricyclic or multicyclic cations. A preferred example is the following 1,4,5,6-Tetrahydropyrimidine cation shown below.

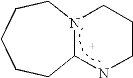

Alkyl groups where one or more hydrogens are replaced by one or more halogens selected from the group consisting of fluorine, chlorine, bromine and iodine and combinations thereof, are termed haloalkyls.

The anion of the molten salt is selected from the group consisting of organic carbonate anions and organic sulfite anions and combinations thereof. Organic carbonate anions are selected from the group consisting of RCO₃⁻, R(CO₃)₂²⁻, R(CO₃)₃³⁻ and and R(CO₃)ₙⁿ⁻ and combinations thereof, where R is selected from the group consisting of C₁-C₁₅ alkyl and C₁-C₁₅ haloalkyl and combinations thereof and n is a positive integer. Organic sulfite anions are selected from the group consisting of RSO₃⁻, R(SO₃)₂²⁻, R(SO₃)₃³⁻ and R(SO₃)ₙⁿ⁻ and combinations thereof, where R is selected from the group consisting of C₁-C₁₅ alkyl and C₁-C₁₅ haloalkyl and combinations thereof and n is a positive integer.

Additional salt can be dissolved in the molten salt. The additional salt contains a cation selected from the group consisting of Li⁺, Na⁺, K⁺, Ag⁺, Rb⁺, Cs⁺, Mg²⁺, Ca²⁺, Fe²⁺, Fe³⁺, Cu⁺, Cu²⁺, Zn²⁺, Al³⁺ and R₄X+ and combinations thereof, where R is selected from the group consisting of H, halogens, C₁-C₅ alkyl and C₁-C₅ haloalkyls and combinations thereof and where X is selected from the group consisting of N and P and combinations thereof. The additional salt contains an anion selected from the group consisting of ClO₄⁻, AlCl₄⁻, NO₃⁻, CO₃²⁻, SO₄²⁻, PF₆⁻, AsF₆⁻, SbF₆⁻, Cl⁻, Br⁻, I⁻, CₙR¹₍₂ₙ₊₁₎Q¹⁻, CF₃SbF₅SO₃⁻, B₁₀Cl₁₀²⁻, B₁₂Cl₁₂⁻², B₄O₇²⁻, R²₄B⁻, ⁻N(Q²R³)(Q³R⁴) and ⁻C(Q⁴R⁵)(Q⁵R⁶)(Q⁶R⁷) and combinations thereof where n=1 to 5 and R¹ to R⁷ are the same or different and are selected from the group consisting of H, halogens, C₁-C₅ alkyl and C₁-C₅ haloalkyls, including bridging C₁-C₅ alkyl and C₁-C₅ haloalkyls that link Q² and Q³, Q⁴ and Q⁵, Q⁴ and Q⁶, Q⁵ and Q⁶, and combinations thereof, where Q¹ to Q⁶ are the same or different and are selected from the group consisting of CO and SO₂. ⁻N(Q²R³)(Q³R⁴) and ⁻C(Q⁴R⁵)(Q⁵R⁶)(Q⁶R⁷) are shown below.

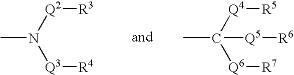

For a lithium ion conductive electrolyte, suitable for use in electrochemical capacitors and lithium and lithium-ion batteries, preferred lithium salts include, but are not limited to, LiPF₆, LiAsF₆, LiSbF₆, LiSO₃CF₃, LiN(SO₂CF₃)₂, LiC(SO₂CF₃)₃, LiCO₃ and LiNO₃. For electrochemical capacitors, preferred salts include, but are not limited to, (C₂H₅)₄NBF₄, (C₂H₅)₄PBF₄ and (C₂H₅)₄NClO₄.

The electrolyte may contain an anionic polymer lithium salt such as, but not limited to, polyvinyl lithium sulfonate, sufficient to prevent electrolyte crystallization.

The electrolyte may contain high-boiling, high dielectric constant, cyclic solvents selected from the group consisting of cyclic carbonates and cyclic halogenated carbonates and combinations thereof. Cyclic carbonates include, but are not limited to, ethylene carbonate, propylene carbonate, 1,2-butylene carbonate and vinylene carbonate. Cyclic carbonates where one or more hydrogens are replaced by one or more halogens selected from the group consisting of fluorine, chlorine, bromine and iodine and combinations thereof, are termed cyclic halocarbonates. Preferred cyclic halocarbonates include, but are not limited to, chloroethylene carbonate. These high-boiling and high dielectric constant, cyclic solvents assist in forming a passivation layer at electrode/electrolyte interfaces.

Molten salts are sometimes viscous presenting a problem wetting electrodes and separator already folded or rolled into a jellyroll and already in an external can or other packaging. An electrochemical device can be filled and wetted with the molten salt or, preferably, with the amine base and alcohol which are then converted to the molten salt with the addition of a non-metal oxide such as CO₂. Additional salt is added at any time.

What is claimed is:

1. An electrolyte comprising:
a cyclic organic cation;
an anion selected from the group consisting of organic carbonate anions and organic sulfite anions and combinations thereof; and
additional salt.

2. The electrolyte of claim 1 wherein the cyclic organic cation is DBU cation.

3. The electrolyte of claim 1 wherein the anion is 1-hexylcarbonate anion.

4. The electrolyte of claim 1 further comprising high-boiling, high dielectric constant, cyclic solvents.

5. The electrolyte of claim 1 further comprising anionic polymer lithium salt.

6. An electrochemical device comprising:
at least two electrodes; and
an electrolyte comprising a cyclic organic cation and;
an anion selected from the group consisting of organic carbonate anions and organic sulfite anions and combinations thereof.

7. The electrochemical device of claim 6 wherein the electrolyte further comprises another salt.

8. The electrochemical device of claim 6 wherein said cyclic organic cation is DBU cation.

9. The electrochemical device of claim 6 wherein said anion is 1-hexylcarbonate anion.

10. A method for filling an electrochemical device comprising at least two electrodes with electrolyte, the method comprising:
filling the electrochemical device with a non-ionic liquid; and
converting the non-ionic liquid to an ionic liquid.
